(19) United States
(12) Patent Application Publication
(10) Pub. No.: US 2014/0360669 A1
(43) Pub. Date: Dec. 11, 2014

(54) METHOD OF HEAT SEALING WOVEN POLYPROPYLENE TYPE FABRICS

(71) Applicants: AMERIGLOBE, LLC, Lafayette, LA (US); DOW GLOBAL TECHNOLOGIES LLC, Midland, MI (US)

(72) Inventors: Daniel R. SCHNAARS, SR., Lafayette, LA (US); Clifford DUNLAP, Baton Rouge, LA (US); Lori KARDOS, Sugarland, TX (US); Rajen PATEL, Lake Jackson, TX (US)

(21) Appl. No.: 14/297,331

(22) Filed: Jun. 5, 2014

Related U.S. Application Data
(60) Provisional application No. 61/831,476, filed on Jun. 5, 2013.
(60) Provisional application No. 61/890,664, filed on Oct. 14, 2013.
(60) Provisional application No. 61/909,737, filed on Nov. 27, 2013.
(60) Provisional application No. 61/994,642, filed on May 16, 2014.

(51) Int. Cl. B32B 37/12

(52) U.S. Cl. CPC B32B 37/12; B32B 2309/02; B32B 2309/12; B32B 2323/10
USPC 156/334; 156/60

(57) ABSTRACT

A method of joining highly oriented polypropylene woven fabrics by the steps of coating the fabrics with materials that have a melting point that is lower than the melting point of the polypropylene fabrics to be joined together; heating the coating to its lower melting point; and joining the heated materials with pressure light enough to allow the coating to stay in place and generally not allowing the woven fabrics to touch.

### CROSS-REFERENCE TO RELATED APPLICATIONS

Priority of U.S. Provisional Patent Application Ser. No. 61/831,476, filed on 5 Jun. 2013; U.S. Provisional Patent Application Ser. No. 61/890,664, filed on 14 Oct. 2013; U.S. Provisional Patent Application Ser. No. 61/909,737, filed on 27 Nov. 2013, and U.S. Provisional Patent Application No. 61/994,642, filed 16 May 2014, each of which is hereby incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to a method of connecting woven polypropylene fabrics or similar fabrics without the use of sewing machines and sewing threads, applicable to any product in which one wishes to connect polypropylene fabrics or similar fabrics without the use of sewing machines.

2. General Background of the Invention

Woven polypropylene fabrics have been the fabric of choice in certain industries, for example the bulk bag industry and the small woven bag industries, given the strength, cost and flexibility of the fabrics. Although woven polypropylene fabrics are very strong, they are also very chemically inert. The polypropylene fabrics are highly oriented through a heating and stretching process to achieve maximum strength while maintaining the needed flexibility of fabrics to fit the needs of the marketplace. Due to these properties, it is very difficult to find a method of connecting two polypropylene fabrics without damaging the fabric itself, thereby reducing notably the strength and usefulness of the fabrics.

Sewing has been the method of choice when connecting polypropylene fabrics. The act of sewing however, reduces the fabric strength through the needle punctures. The average sewn seam in these high strength woven polypropylene fabrics creates seams that are generally about 63% of the strength of the unsewn fabrics.

Therefore, in order for the seams to be strong enough, the fabrics themselves must be constructed thicker and stronger to make up for the loss of strength in the seam.

Many efforts have been made to find an acceptable alternative to sewing polypropylene fabrics for several reasons.

1. The act of sewing creates thread ends that must be cut from the end of each sew line. These ends often get loose and can become unwanted contamination within the resulting product or packaging.

2. Because of the high heat generated by the needles passing through this tough polypropylene fabric, threads are often breaking. This causes production to momentarily stop while the machine is re-threaded.

3. Sewing machines can run at speeds of several thousand stitches per minute. At this high speed with many mechanical parts, there is a high incidence of parts breakage and needle breakage which stops production of that machine while it is repaired.

4. Because of points 2 & 3, the production of polypropylene products requires a high amount of labor to operate these machines and deal with these issues. Global bag production using polypropylene fabrics, for example, has largely taken place outside the United States, to be produced in countries with abundant sources of low wage labor.

Furthermore, even sewing seams reduce the strength of the polypropylene or other similar fabrics as the needle punctures break the fibers in the area and reduce the fabric total strength. The number of stitches in each inch (centimeter) of the seam, the needle size and the thickness of the thread used to make the stitch, all play a part in the overall strength of the resulting seam. Often these seams produce a joint that is about 63 to 70% of the strength of the unstitched fabric. Due to the weakening of the seams, fabrics that are 30% stronger than would be theoretically needed to carry the various weights are designed. For all of these reasons, an alternative to sewing has been desired and sought after within the industry for many years.

Various glues and various welding methods have been tried for connecting polypropylene fabrics.

Contact glues have been found unsuccessful due to:

1. poor peeling strengths;

2. the lack of a permanent bond, (contact glues stay active so they can be peeled and reattached over and over);

3. a bond that is easily affected by temperature changes (glue often melts at very low temperatures and becomes inactive in cooler temperatures); and

4. shear strength that is only attained with very large area type coverage.

Solvent glues have also failed due to the following:
a. joints are brittle and inflexible;
b. often involve hazardous elements not allowable in food packaging; and
c. fabric strength is reduced by molecular reconfiguration.

Heat welding has been tried and largely rejected because to heat weld as in the prior art, one must reach the melting point of the polypropylene fabrics to bond them together. However, the polypropylene fabrics are highly oriented and bringing them up to this temperature level results in a fabric tensile strength loss of approximately 50%.

Laser welding has been tried and showed some marginal success but this method is not economically feasible due to low production rates and very high capital costs.

The art of heat sealing is well known in plastic fabric industries such as those industries using polyethylene or PVC fabrics. Heat sealing equipment is useful in that it is significantly more amenable to automation than sewing machines. It has far less moving parts and can be electronically supervised for dependable repeatability.

In the prior art, polyethylene fabrics are heated up past their melting point, then squeezed together with sufficient pressure (for example, 20 psi (137 kilopascal)) to be sure the fabrics meet and join for a pre-determined amount of time, and the joint is made. This joint is typically around 80 to 85% of the original strength of the materials. Since these materials are not so highly oriented, as compared to polypropylene, this high heat method results in an acceptable joint. In the prior art, pressure may generally be applied at approximately 20 psi (137 kilopascal) across the entire joint area to squeeze the laminations out. Heat is applied at temperatures significantly over the melting point of the polyethylene fabric so that the laminations would become liquefied and the surface of the woven portions would also become melted. The liquefied lamination was then squeezed out from between the fabrics and the melted surfaces of the fabrics themselves were used to make the joint. Example melting points of some polyethylene fabrics may be 235 or 265 degrees Fahrenheit (112.8 or 129.4 degrees Celsius). High and low density polyethylene fabrics are made in the prior art, and different polyethylene fabrics may have different melting points, wherein low density polyethylene generally has a lower melting point than high density polyethylene. Temperatures for example of 425 to 500 degrees Fahrenheit (218.3 to 260 degrees Celsius) are applied in the prior art to melt the laminated film and polyethylene fabric.

However, polypropylene is so highly oriented that use of current or standard heat sealing procedures, which call for temperatures exceeding the melting point of the fabrics, results in the strength of the polypropylene fabric itself being immensely deteriorated. Testing conducted with regard to developing the present invention has shown an average loss of tensile strength of approximately 50% when polypropylene fabric is joined through standard heat sealing methods, wherein the fabric is heated to a temperature exceeding the melting point of the fabric. This then results in joint strengths that are significantly less than joint strengths currently available through sewing polypropylene fabrics. Thicker stronger fabrics may then be preferred to be used so that the final strength of a resulting product will safely lift the required weights necessary for the product. Further, such joints produced through heat sealing polypropylene fabric with standard heat sealing methods show a measure of crystallization in the joint area which also reduces the flexibility of the fabrics in the joint areas.

There is thus a need in the industry to produce products comprising polypropylene fabrics, for example woven bags designed to carry 25 to 100 pounds (9.33 to 46 kilograms) or less and bags designed to carry very heavy weights such as bulk bags (which, for example, in some cases carry up to 4,400 pounds (1,996 kilograms)).

There is also a need in the industry to produce products comprising polypropylene fabrics by heat sealing instead of stitching the parts together because the use of sewing machines may involve high amounts of labor. Further, thread contamination will always be a possibility and powders sifting through the sewn seams will always be a concern as long as sewing is used to make the seams.

Additionally, while sewing machines might be able to be automated, they have not been able to run in an automated manner. Threads break as heat builds up and an operator is needed to re-string the machine with new threads. These machines operate at high speeds and often skip stitches. This requires an operator to see this quality issue and repair it right away.

The present invention seeks to provide an alternative method of connecting woven polypropylene fabrics or similar fabrics without the use of sewing machines and sewing threads. The present invention will apply to any product in which one wishes to connect polypropylene fabrics or similar fabrics without the use of sewing machines. The present invention will be useful in industries using smaller polypropylene bags (for holding 25 to 100 lbs (9.33 to 46 kilograms)) and will also be applicable to larger fabric bulk bags (for holding weights ranging up to 3,300 lbs (1,497 kilograms), and up to 4,400 lbs (1,996 kilograms) in some cases.).

Another object of this invention is to design a sealing system that can utilize simple robots for automation in the construction of flexible fabric containers.

It is a further object of the present invention that a product made by heat sealing versus sewing will have many advantages such as reduced sifting, reduced manpower, thinner materials, reduced contamination and improved repeatability through automation.

It is a further object of the present invention that the flexible fabric products made by heat sealing will have great marketplace appeal for those companies for whom any thread contamination would jeopardize the quality of their product. Such companies would be in the food or electronics or medical or pharmaceutical industries. These bags would have no threads to pose a contamination threat as there would be no sewing.

It is a further object of the present invention to provide a flexible fabric product that would have great appeal to those companies who are concerned about sifting of their product through the needle holes left by the sewing process. Such companies may include the carbon black companies, where very tiny amounts of their product can make very large messes. Other companies may include companies whose products are going into sensitive end user environments where small amounts of their products would contaminate the area.

It is a further object of the present invention to provide a flexible fabric product that would be useful for companies who are using polyethylene liners to prevent sifting and contamination. Liners add additional costs to woven bags, for example, and make them more difficult to work with.

It is a further object of the present invention to provide a method that allows companies to pursue full automation for woven fabric product production.

It is a further objective of the present invention to use heat sealing equipment, which can be automated, to produce polypropylene products without requiring stitched seams or sewing machines.

It is also an objective of the present invention to use heat sealing methods to produce products comprising polypropylene fabrics, without requiring stitched seams or sewing machines.

A further objective of the present invention is to provide a heat sealed polypropylene product that may be manufactured without human touch on the inside of the product, so as to maintain a sterile product and help eliminate a concern regarding bacterial contamination of polypropylene storage products, as well as to eliminate the possibility of leakage through sewing holes, so that the product may be useful in medical applications, for example in the pharmaceutical industry.

### BRIEF SUMMARY OF THE INVENTION

The method of the present invention solves the problems confronted in the art in a simple and straightforward manner What is provided is an alternative method of connecting woven polypropylene fabrics by using heat without the use of sewing machines and sewing threads. This invention also relates to the ability to produce products involving connecting polypropylene fabrics or similar fabrics, with minimal labor, thereby allowing such products to be made in all areas of the world where the products are needed, versus only being produced in volume in those areas of the world with large amounts of low wage labor.

In developing the present invention, testing and experimentation was conducted. For example, testing and experimentation with heat sealing polypropylene fabric was conducted. Test results showed that these fabrics are highly oriented for strength. This high orientation and the molecular structure of polypropylene made efforts to connect two pieces of this material difficult. To join polypropylene pieces of fabric required such a level of heat that the polypropylene fabric simply crystallized making it brittle and not helpful for the purpose of lifting great weights.

Besides crystallizing the fabric, heat sealing polypropylene fabric using standard procedures known in the art resulted in seams with two distinctly different strengths. In seaming operations, including when sewing, there exists a “shear strength” and a “peel Strength”. For example, the lift loops sewn to the side walls of a fabric bag have amazing strength when pulled straight up as this motion utilizes the shear strength of this joint, where the entire joint is sharing the load at all times. But if the bag is lying on its side and it is picked up by one loop, the joint is temporarily put into a position where the peel strength becomes critical, where one edge of the joint is attacked. Thus in shear strength position, the entire joint is sharing the load at all times. In the peel strength position, only one edge of the joint is attacked or bearing the load. As that edge fails, the next edge and then the next edge fail in sequence.

In further testing conducted with polypropylene fabrics, different glues were tested for making usable joints with polypropylene fabric. Test results using Super Glue showed that Super glue did not achieve a 20 pound (9.07 kilogram) shear strength.

An embodiment of the present invention comprises a method of joining highly oriented polypropylene woven fabrics by the following steps:

a) coating the fabrics with materials that have a melting point that is lower than the melting point of the polypropylene fabrics to be joined together;

b) heating the coating to above its lower melting point but below the melting point of the fabric; and

c) joining the heated materials with pressure light enough to allow the coating to stay in place and generally keep the woven fabrics from touching.

In another embodiment of the method of the present invention, the fabrics are not being heated up past their melting points.

In another embodiment of the method of the present invention, the fabrics are not being heated up past their melting points. The fabrics are only being heated to a point below the melting point of the woven fabric but high enough to melt the coating.

In another embodiment of the method of the present invention, by using such relatively low heat, the inventive process does not damage or reduce the strength of the fabric.

In another embodiment of the method of the present invention, only low pressure is being applied to clamp the fabrics together to complete the seal.

In another embodiment of the method of the present invention by using low heat and low pressure, only the coating itself is being joined, leaving the fabric completely undamaged and unweakened.

In another embodiment of the method of the present invention the strength of the coating adds to the overall joint strength, and resulting joint strengths, and allows one to lift greater weights with less material than can be done with the current, commonly used methods of sewing fabrics together.

In another embodiment of the method of the present invention the fabrics are similar to polypropylene.

In another embodiment of the method of the present invention the fabrics are woven of a plastic material other than polypropylene.

In another embodiment of the method of the present invention coating on the fabrics comprises about a 2.5 mil (0.0635 mm) thickness.

In another embodiment of the method of the present invention the coating on the fabrics is applied to a thickness of 1 mil (0.0254 mm) to 2.5 mil (0.0635 mm).

In another embodiment of the method of the present invention, the method is for creating a new form of heat welded seam for polypropylene fabrics that provides as high as a 97% seam strength in the shear position.

Another embodiment of the method of the present invention comprises using heat to combine the laminated coatings of the fabrics versus trying to combine the fabrics themselves. Since the coatings have a marginally lower melting point than the fabric itself, this invention joins polypropylene fabrics without damaging the tensile strength of the original fabrics.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 illustrates a heat sealed seam or joint of an embodiment of the present invention; and

FIG. 2 illustrates use of a heat seal bar in an embodiment of the heat seal method of present invention.

### DETAILED DESCRIPTION OF THE INVENTION

As previously discussed herein, woven polypropylene fabrics are very strong but are also very chemically inert. Due to these properties, it is very difficult to find a method of connecting two pieces of fabric without damaging the fabric itself, thereby reducing notably the strength and usefulness of the fabric. Even sewing seams reduce the strength of the fabric as the needle punctures break the fibers in the area and reduce the fabric total strength. The number of stitches in each inch (centimeter) of the seam, the needle size and the thickness of the thread used to make the stitch, all play a part in the overall strength of the resulting seam. Often these seams produce a joint that is about 63 to 70% of the strength of the unstitched fabric. Due to the weakening of the fabrics, fabrics are utilized which are 30% stronger than would be theoretically needed to carry the very heavy weights that bulk bags, for example, are designed to carry.

As previously discussed, in the present art of heat sealing, polyethylene fabrics are heated up past their melting point, then squeezed together with sufficient pressure to be sure the fabrics meet and join for a pre-determined amount of time and the joint between the fabrics is made. This joint is typically around 80 to 85% of the original strength of the materials. Since these materials are not so highly oriented, this high heat results in an acceptable joint.

However, polypropylene is so highly oriented that when current or standard heat sealing procedures which call for temperatures exceeding the melting point of the fabrics results in the strength of the fabric itself being immensely deteriorated, and may cause a loss of tensile strength of approximately 50%.

In the method of the present invention, what is provided is a heat sealing method that does not substantially damage the strength of the polypropylene fabric yet still gets a final joint strength equal to or exceeding the strength of the current sewing methods. An embodiment of the present invention provides joint strengths of 90 to 96% of the strength of the polypropylene fabrics which is considerably above the joint strength of seams achieved through sewing. Another embodiment of the present invention provides joint strengths of 100 to 102% of the strength of the polypropylene fabrics.

This invention will then aid and allow the automation of woven polypropylene products, thus freeing up the location of factories around the world. Due to the improved joint strength, this invention will also enable the use of thinner materials to accomplish the lifting of similar weights.

In an embodiment of the method of the present invention, a coating is being applied to the polypropylene fabrics or similar fabrics that provide up to 200 lbs (90.7 kilograms) of hold or grip to the polypropylene fabric from a heat seal of 2 inches (5.08 cm) wide across the joint area. In another embodiment of the present invention a coating is being applied to the polypropylene fabrics or similar fabrics that provide up to 240 lbs (108 kilograms) of hold or grip to the polypropylene fabric. The coating has a melting point which is lower than the melting point of the fabrics being joined together. The method of heat sealing provides a substantial improvement over the prior art in the woven fabrics industry.

In an embodiment of the method of the present invention, the fabrics are not being heated up past their melting points. The fabrics are only being heated to the melting point of the coating which is lower than the melting point of the fabrics being joined together, which is useful in preventing degradation and crystallization of the polypropylene fabric as discussed above. In testing conducted with regard to the method of the present invention, the joining temperatures have been 5 degrees less than the melting point of polypropylene. Different polypropylene fabrics may have different melting points, and in the method of the present invention, the fabrics are heated to the melting point of the coating, which is lower than the melting point of the polypropylene fabrics being joined. By using such relatively low heat, the method of the present invention does not damage or reduce the strength of the fabric as typically happens when using the current high heat formulas for heat welding today. Further, the clamping pressure used to make the seal is designed to be low enough to leave the coating largely in place and the materials to be joined, largely separated by the coatings.

Typically, the clamping process of the prior art is designed to purposefully melt and push aside any coatings on the fabric and join the fabric yarns directly. Naturally, when any part of the fabric yarns are heated to and past their melting point and that is combined with high pressure, the yarns are thinned out, weakened and partially crystallized.

In the present invention, using low heat, only the coating itself is being joined. This leaves the fabric completely undamaged and unweakened. In fact, the strength of the coating now adds to the overall joint strength rather than being squeezed out, which occurs in the current methods. With the resulting joint strengths of the present invention, the present invention enables the ability to lift greater weights with less material, than can be done with the current, commonly used prior art methods of sewing fabrics together, or when using standard, known prior art heat sealing methods.

In a preferred embodiment, the coating materials have a melting point lower than the fabrics to be joined. The coating materials in the process may be any suitable material or materials which may be used to successfully carry out the process, and could be selected from a range of coating materials. The coating may comprise propylene copolymers or propylene based plastomers and elastomers. A suitable coating, for example, may be a propylene plastomer and elastomer, for example VERSIFY™ 3000, a product produced by The Dow Chemical Company. A suitable coating may contain 50% to 90% polypropylene based polymer and 10%-50% polyethylene, by weight. VERSIFY™ is a registered trademark of The Dow Chemical Company for propylene-ethylene copolymers used as raw materials in the manufacture of films, fibers and a wide variety of molded plastic objects; propylene-ethylene copolymers used as raw materials in the manufacture of compounds to make coated fabrics, artificial leather, soft touch grips, shoe stiffeners and flexible roofing membranes. The VERSIFY® plastomers and elastomers are a versatile family of specialty propylene-ethylene copolymers produced using a revolutionary catalyst in conjunction with Dow's proprietary INSITE™ Technology. In tests where VERSIFY™ 3000 has been used in an embodiment of the method of the present invention, the method of the present invention has used a mixture of a minimum of 70% pure VERSIFY™ and 25% Polyethylene and 5% of additives such as UV protection and colors. Other potential additives may include Ultra Violet Inhibitors or anti-static protection. Testing has been conducted with 100% and 70% of the coating being formulated with VERSIFY™ 3000. At 100%, the method of the present invention achieved up to 96% to 102% joint efficiency in a shear joint tensile test, while at 70% VERSIFY™ 3000, 91% to 95% joint efficiency has been obtained in the same test. The resulting percentages are based on the average strength of the fabric tested. There is generally approximately a 5% variable strength in any section of fabric tested.

In a preferred embodiment of the present invention, the coating is applied at about a 2.5 mil (0.0635 mm) thickness. Standard industry coatings are typically applied at 1 mil (0.0254 mm) thickness.

In another embodiment of the present invention coatings will be applied to the fabrics at a thickness of 1 mil to 2.5 mil (0.0254-0.0653 mm)

Additional embodiments of the present invention may use coatings containing mixtures of VERSIFY™ and polyethylene, wherein the percentage of VERSIFY™ is less than 70% to produce a joint efficiency under 90%, as may be suitable based on certain product applications and industry demands.

Additional embodiments of the present invention may use coatings comprising propylene copolymers, polyethylene and additives.

A suitable coating may be a propylene plastomer and elastomer, for example VERSIFY™ 3000. The coating may contain for example 50% to 90% polypropylene based polymer and 10%-50% polyethylene, by weight.

In a coating to be used in a preferred method of the present invention for heat joining polypropylene fabric, one can use 10-99%, preferably 20-95%, more preferably 30-95%, and most preferably 75-90% propylene plastomers, elastomers, or combinations thereof;

one can use 0-5% additives for color, anti-static, or other purposes (these do not materially affect the performance of the coating, and are typically minimized as they are more expensive than the propylene and polyethylene);

the balance is preferably polyethylene plastomers, elastomers, or combinations thereof.

Preferably, the propylene plastomers, elastomers, or combinations thereof have a density of 0.915 to 0.80 grams per cc, and more preferably 0.905 to 0.80 grams per cc. Preferably, the polyethylene plastomers, elastomers, or combinations thereof have a density of 0.91 to 0.925 grams per cc. Typically, one should use at least 5% low density polyethylene to make the coating run, and preferably at least 10%.

### EXAMPLE

In a preferred embodiment of the present invention, the fabrics are only being heated to the melting point of the coating which is lower than the melting point of the fabrics being joined together. In a preferred embodiment of the present invention, the joining temperatures are at least 5 degrees less than the melting point of the polypropylene fabrics to be joined. Different polypropylene fabrics will have different melting points, and in an embodiment of the method of the present invention, the joining temperatures are at least 5 degrees less than the melting point of the particular polypropylene fabrics to be joined. An example polypropylene fabric may have a melting point of 320 degrees Fahrenheit (176.7 degrees Celsius), and thus in an embodiment of the present invention, the coating will be heated to 315 degrees Fahrenheit (157.22 degrees Celsius). By using a lower heat than the polypropylene fabrics, the method of the present invention does not damage or reduce the strength of the fabric as typically happens when using the prior art high heat formulas for heat welding. Further, in an embodiment of the present invention, the clamping pressure used to make the seal is designed to be low enough (for example 7 psi (48 kilopascal)) to leave the coating largely in place and the materials to be joined, largely separated by the coatings. Clamping pressures may also be lower, for example under 2 psi (13.8 kilopascal). Typically in the prior art heat sealing methods, the clamping process is designed to purposefully melt and push aside any coatings on the fabric and join the fabric yarns directly. When any part of the fabric yarns are heated to and past their melting point and that is combined with high pressure (for example 20 psi (137.9 kilopascal)), the yarns are thinned out, weakened and partially crystallized.

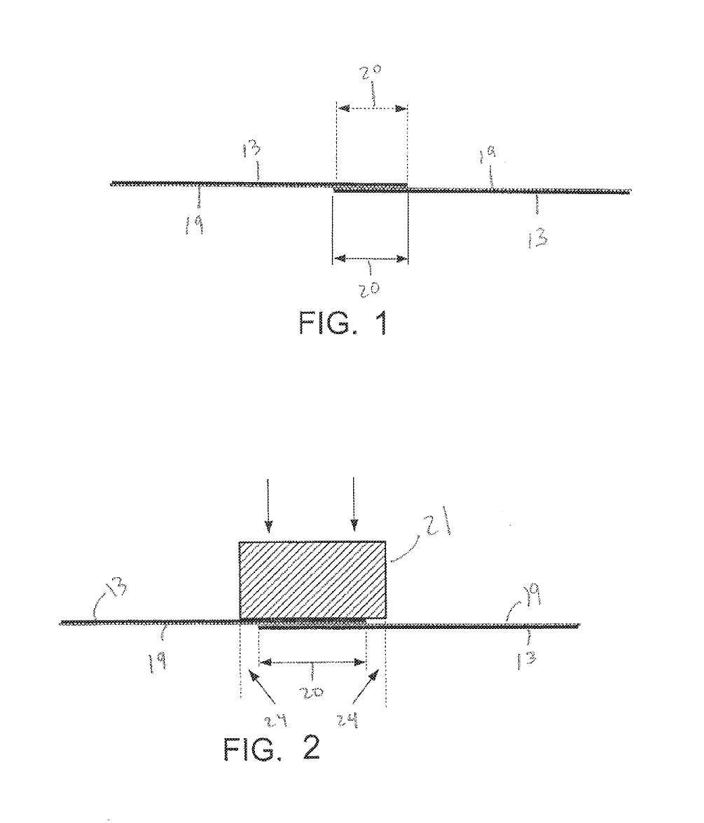

FIGS. 1-2, depict an embodiment of the method of the present invention. FIG. 10 depicts a heat seal seam of the present invention. In FIG. 10, fabric 13 is shown as a dark line. Coating or lamination 19 of the fabrics is shown as a dotted line. Line 20 depicts the sealed or joined area of fabric, which, for example, may be 1½ to 2 inches (3.8 cm to 5.1 cm).

Different sized joint or sealed areas may be used based on the particular application for which the joined fabric will be used. In an embodiment of the present invention the width of the overlap can be much smaller, for example 0.5 inches (1.25 cm) to save even more fabrics.

It is preferable, that the seams be sealed in a manner that no graspable edge be left on any potential exterior seam. This will discourage any attempt to rip the seal open in the peel position which is the weak direction of the fusion joint.

In an embodiment of the present invention, the preferred method is to overlap the fabrics only 1½ inches (3.81 cm) and center this under a 2 inch (1.25 cm) wide, for example, seal bar 21 as shown in FIG. 2. In FIG. 2, line 20 depicts the sealed area, which may be 1½ inches (3.81 cm) wide. This intentionally leaves a ¼ inch (0.64 cm) gap or transitional area, represented by arrow 22, on either side of the joint or sealed area 20. This insures that the ending edges of the two halves of the seal are sealed to the very edge. This leaves no graspable edge to create an easily peelable area.

The ¼ inch (0.64 cm) transitional area is small enough to prevent damaging heat from overcoming the smaller material volume of the single layer and allows for some small misplacement of the fabric edge lineup.

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A method of joining polypropylene woven fabrics by the following steps:
a) coating the fabrics with materials that have a melting point that is lower than the melting point of the polypropylene fabrics to be joined together;
b) heating the coating to at least the melting point of the coating; and
c) joining the heated materials with pressure light enough to allow the coating to stay in place and generally keep the woven fabrics from touching.

2. The method in claim 1, wherein the fabrics are not being heated up past their melting points.

3. The method in claim 1, wherein the fabrics are only being heated to a point below the melting point of the woven fabric but high enough to melt the coating.

4. The method in claim 3, wherein by using such relatively low heat, the inventive process does not damage or reduce the strength of the fabric.

5. The method in claim 1, wherein low pressure is applied to clamp the fabrics together to complete the seal.

6. The method in claim 5, wherein the pressure is under 7 psi (48 kilopascals).

7. The method in claim 5 wherein the pressure is 2 to 7 psi (14 to 48 kilopascals).

8. The method in claim 5 wherein the pressure is under 2 psi (14 kilopascals).

9. The method in claim 1, wherein by using low heat and low pressure, only the coating itself is being joined, leaving the fabric completely undamaged and unweakened.

10. The method in claim 1, wherein the strength of the coating adds to the overall joint strength, and resulting joint strengths, allows one to lift higher weights with less material than can be done with the current, commonly used methods of sewing fabrics together.

11. The method in claim 1 wherein the fabrics are similar to polypropylene.

12. The method in claim 1 wherein the fabrics are woven of a plastic material other than polypropylene.

13. A method of joining highly oriented polypropylene woven fabrics by the following steps:
a) coating the fabrics with a coating comprising VERSIFY™ and polyethylene resins, the coating having a melting point that is at least 5 degrees lower than the melting point of the polypropylene fabrics to be joined together;
b) heating the coating to its lower melting point; and
c) joining the heated materials with sufficient pressure to allow the coating to remain in place and yet not allow the woven fabrics to make direct contact in order to achieve at least 91% joint efficiency.

14. The method of claim 1, wherein the coating comprises 50% to 90% of propylene-based plastomers, propylene-based elastomers, or mixtures thereof and 10% to 50% polyethylene resins and additives, having a melting point that is at least 5 degrees lower than the melting point of the polypropylene fabrics to be joined together.

15. The method of claim 1, wherein the coating comprises 50% to 90% of VERSIFY™ 3000 and 10% to 50% polyethylene resins, having a melting point that is at least 5 degrees lower than the melting point of the polypropylene fabrics to be joined together.

16. The method of claim 1, wherein the coating comprises 50% to 90% of a propylene copolymer and 10% to 50% polyethylene resins.

17. The method in claim 1 wherein the coating has a melting point that is at least 15% lower than the melting point of the polypropylene fabrics to be joined together.

18. A method of joining highly oriented polypropylene woven fabrics by the following steps:
a) coating the fabrics with materials comprising about 70% VERSIFY™ and about 30% polyethylene resins, having a melting point that is at least 5 degrees lower than the melting point of the polypropylene fabrics to be joined together;
b) heating the coating to its lower melting point; and
c) joining the heated materials with sufficient pressure to allow the coating to remain in place and yet not allow the woven fabrics to make direct contact in order to achieve at least 91% joint efficiency.

19. (canceled)
